(19) United States
(12) Patent Application Publication
(10) Pub. No.: US 2025/0121855 A1
(43) Pub. Date: Apr. 17, 2025

(54) Unsupervised Maneuvering of a Vehicle in a Parking Facility

(71) Applicant: Bayerische Motoren Werke Aktiengesellschaft, Muenchen (DE)

(72) Inventors: Thomas SCHALLER, Wurmsham (DE); Denis ZIEGEL, Muenchen (DE)

(21) Appl. No.: 18/912,770

(22) Filed: Oct. 11, 2024

(30) Foreign Application Priority Data
Oct. 13, 2023 (DE) 10 2023 128 114.3

(51) Int. Cl. B60W 60/00; B60Q 1/50; B60Q 5/00

(52) U.S. Cl. CPC B60W 60/0017; B60Q 1/507; B60Q 1/525; B60Q 5/006

(57) ABSTRACT

A method for unsupervised maneuvering of a vehicle as well as a corresponding automotive control unit and a vehicle are provided. Prior to causing the vehicle to autonomously depart a parking position without supervision, the vehicle performs a first pre-departure movement configured to prevent endangering VRUs in a vicinity of the vehicle. The parking position is located outside of a field of view of the user. In response to receiving a command from a user of the vehicle instructing the vehicle to autonomously drive to a vehicle retrieval location, the vehicle drives autonomously to the vehicle retrieval location.

### CROSS REFERENCE TO RELATED APPLICATION

This application claims priority under 35 U.S.C. § 119 from German Patent Application No DE 10 2023 128 114.3, filed Oct. 13, 2023, the entire disclosure of which is herein expressly incorporated by reference.

### BACKGROUND AND SUMMARY

The invention generally relates to unsupervised maneuvering of a vehicle in a parking facility and more precisely to preventing injury of vulnerable road users (VRUs) while the vehicle autonomously and without supervision traverses the parking facility.

A modern vehicle is typically equipped with a plurality of sensors in order to determine the environment of the vehicle, such as by detecting VRUs in the vicinity of the vehicle. However, the plurality of sensors may only determine the environment while the vehicle is turned on. If the vehicle is initially parked in a parking facility, the vehicle and thus the plurality of sensors may only be turned on once the vehicle is summoned by its user to a vehicle retrieval location. In such a situation, the plurality of sensors may initially be unaware of VRUs if the VRUs are positioned outside of the capture area of the plurality of sensors prior to the vehicle and/or the VRUs moving. Further, while the vehicle is occupied by the user during movement of the vehicle, the user may be aware of the VRUs outside of the capture area of the plurality of sensors, providing an additional layer of safety for such VRUs. However, when the user summons the vehicle to the vehicle retrieval location, this additional layer of safety is not present as the vehicle is typically parked outside the field of view of the user. Accordingly, the vehicle may endanger VRUs during the initial movement of the vehicle toward the vehicle retrieval location. Endangering VRUs during the initial movement of the vehicle may be especially critical in case of children playing in the parking facility under or near the underside of a vehicle. The plurality of sensors typically does not include sensors at the underside of the vehicle due to the increased likelihood of dirt covering sensors at the underside of the vehicle. Accordingly, the area beneath the vehicle is outside the capture area at all times and may also not be inside the field of view of the user of the vehicle. In addition, due to the absence of the user from the vehicle, children may not expect movement of the vehicle, as they normally would if the user approached and entered the car.

Therefore, it is an objective of the present disclosure to prevent injury of VRUs during initial movement of an unsupervised vehicle in a parking facility.

To achieve this objective, the present disclosure provides a method for unsupervised maneuvering of a vehicle. The method comprises, prior to causing the vehicle to autonomously depart a parking position without supervision, causing the vehicle to perform a first pre-departure movement configured to prevent endangering VRUs in a vicinity of the vehicle and in response to receiving a command from a user of the vehicle instructing the vehicle to autonomously drive to a vehicle retrieval location, causing the vehicle to autonomously drive to the vehicle retrieval location, wherein the parking position is located outside of a field of view of the user.

The present disclosure further provides an automotive control unit. The automotive control unit comprises at least one processing unit and a memory coupled to the at least one processing unit and configured to store machine-readable instructions. The machine-readable instructions cause the at least one processing unit to, prior to causing a vehicle to autonomously depart a parking position without supervision, cause the vehicle to perform a first pre-departure movement configured to prevent endangering VRUs in a vicinity of the vehicle; and, in response to receiving a command from a user of the vehicle instructing the vehicle to autonomously drive to a vehicle retrieval location, cause the vehicle to autonomously drive to the vehicle retrieval location, wherein the parking position is located outside of a field of view of the user.

The present disclosure further provides a vehicle comprising the automotive control unit.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a driver summoning a vehicle in a parking facility according to examples of the present disclosure.

FIG. 2 shows a flowchart of a method for unsupervised maneuvering of a vehicle according to examples of the present disclosure.

FIG. 3 illustrates a vehicle according to examples of the present disclosure.

FIGS. 4A and 4B illustrate a pre-departure movement of a vehicle according to examples of the present disclosure.

FIG. 5 illustrates a pre-departure movement of a vehicle according to examples of the present disclosure.

FIG. 6 illustrates a vehicle emitting an alert sound according to examples of the present disclosure.

FIG. 7 illustrates a vehicle flashing at least one light according to examples of the present disclosure.

FIG. 8 illustrates an automotive control unit according to examples of the present disclosure.

It should be understood that the above-identified drawings are in no way meant to limit the present disclosure. Rather, these drawings are provided to assist in understanding the present disclosure. The person skilled in the art will readily understand that aspects of the present invention shown in one drawing may be combined with aspects in another drawing or may be omitted without departing from the scope of the present disclosure.

### DETAILED DESCRIPTION OF THE DRAWINGS

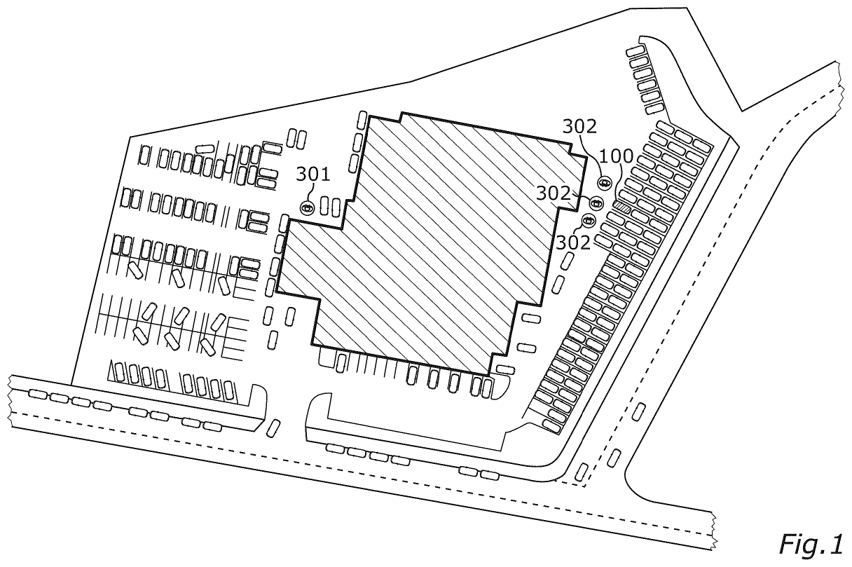

The present disclosure generally provides a method, an automotive controller and a vehicle which ensure the safety of VRUs in the vicinity of the vehicle when the vehicle departs a parking position within a parking facility without supervision, i.e. when the vehicle is summoned by a user of the vehicle to a vehicle retrieval location. It will be understood that the expressions “without supervision” and “unsupervised” in the context of the present disclosure refer to the fact that the vehicle departs the parking position without any passengers and outside of the field of view of the user summoning the vehicle. This concept is illustrated in FIG. 1, which shows a user 301 located on the west side of a building surrounded by a parking facility. User 301 summons vehicle 100, which is located on the east side of the building, to their position. Consequently, user 301 cannot see vehicle 100. In the vicinity of vehicle 100, three VRUs 302 are located. Given that no passengers are present in vehicle 100, the three VRUs 302 may not expect any movement of vehicle 100 and may thus not move out of the path of vehicle 100. This may in particular be true if vehicle 100 is an electric vehicle, as electric vehicles emit no or very limited noise when turning on. Consequently, VRUs 302 may be endangered by vehicle 100. Further, assuming VRUs 302 represent children playing in the vicinity of vehicle 100, situations may occur in which VRUs 302 may be located under or near the underside of vehicle 100, which may not include any sensors, as discussed above.

To ensure the safety of VRUs 302, the vehicle performs a pre-departure movement, which may e.g. be a downward movement, which reduces the ground clearance of vehicle 100. To prevent the issue of children being present under vehicle 100 while playing in the vicinity of vehicle 100, the downward movement may be performed when vehicle 100 initially arrived at the parking position to ensure that the ground clearance can be reduced safely. The pre-departure movement may also be a lateral back and forth movement, e.g. by a few centimeters, in order to alert anybody in the vicinity or even under vehicle 100 to the imminent departure of vehicle 100. Vehicle 100 may also perform both or other types of pre-departure movement and may accompany the pre-departure-movements with an alert sound or flashing of at least one light of vehicle 100 in order to warn any VRUs 302 in the vicinity of vehicle 100 of the imminent departure of vehicle 100 from the parking position.

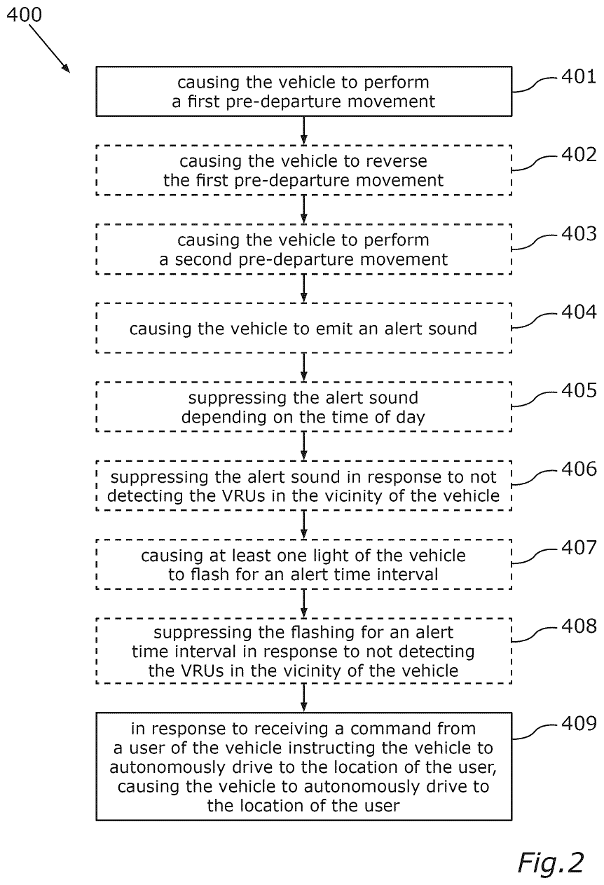

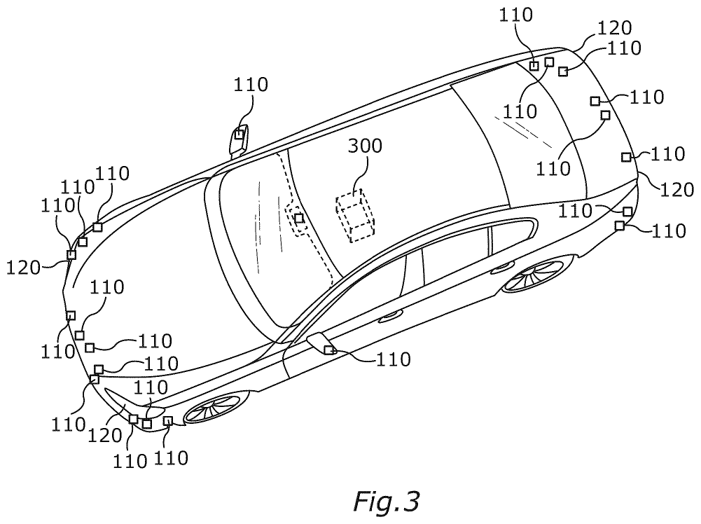

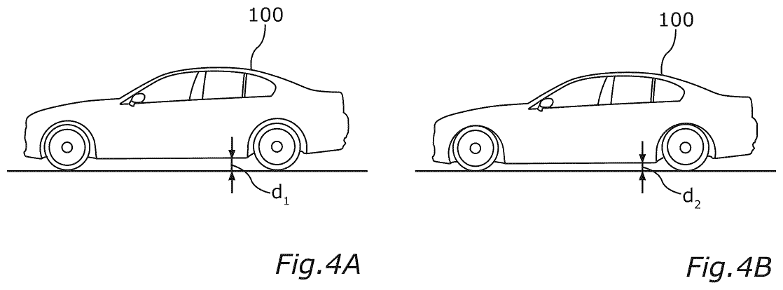

This general concept will be explained with reference to the appended drawings, with FIG. 2 providing a flowchart of a method 400 for unsupervised maneuvering of a vehicle, FIG. 3 illustrating vehicle 100 and FIGS. 4A to 7 illustrating the performance of various steps of method 400. In addition, FIG. 8 illustrates an automotive controller configured to perform method 400.

It will be understood that dashed boxes in FIG. 2 illustrate optional steps of method 400.

Method 400 is configured to maneuver a vehicle, such as vehicle 100 of FIG. 3, without supervision. In other words, method 400 is configured to autonomously drive vehicle 100 toward user 301 with vehicle 100 being at least initially outside of the field of view of user 301 in response to receiving a command from user 301 instructing vehicle 100 to drive to the vehicle retrieval location, which may e.g. be the location of user 301 or a designated vehicle retrieval area of the parking facility. The starting or departure point of vehicle 100 is a parking position within a parking facility. It will be understood that the expression “parking facility” may refer to any type of area or building designed to provide parking spaces for vehicles, such as open ground level parking lots or parking garages located above and/or below ground. Depending on the level of autonomy provided by vehicle 100, the expression “parking facility” may also include on-street parking in the vicinity of user 301.

User 301 is referred to as a user instead of a driver in the context of the present disclosure in order to denote the fact that at user 301 does not drive vehicle 100 at least for the purpose of maneuvering vehicle 100 toward the vehicle retrieval location within parking facilities. Depending on the level of autonomy provided by vehicle 100 outside of parking facilities, user 301 may drive vehicle 100 outside of parking facilities or may rely on autonomous driving capabilities of vehicle 100 at all times or at least during certain traffic conditions or on certain road types.

In step 401, method 400 causes vehicle 100 to perform a first pre-departure movement prior to causing vehicle 100 to autonomously depart the parking position without supervision. The first pre-departure movement is configured to prevent endangering VRUs 302 in a vicinity of the vehicle and is performed by vehicle 100 prior to departing from the parking position. Depending on the type of pre-departure movement, the first pre-departure movement may be performed upon the arrival of vehicle 100 at the parking position or may be performed shortly before departing from the parking position.

For example, the first pre-departure movement may be a downward movement configured to reduce a ground clearance of vehicle 100, as illustrated in FIGS. 4A and 4B. As can be seen in in FIGS. 4A and 4B, the ground clearance is reduced by the downward movement from a first distance d₁ between the underside of vehicle 100 and the ground to a second distance d₂ between the underside of vehicle 100 and the ground. Method 400 may cause vehicle 100 to perform the downward movement by instructing a height adjustable suspension of vehicle 100 to lower the chassis of vehicle 100 and to thereby reduce the ground clearance of vehicle 100. The reduction in ground clearance may prevent children from crawling under the vehicle while playing in the parking facility. To this end, method 100 may perform the downward movement upon arrival at the parking position to prevent children from playing under or near the underside of vehicle 100 while vehicle 100 is parked. To return to the original ground clearance, as e.g. shown in FIG. 4A, method 400 may include step 402, in which method 402 may cause vehicle 100 to reverse the first pre-departure movement before causing the vehicle to drive to the vehicle retrieval location. Method 400 may cause vehicle 100 to reverse the first pre-departure movement by instructing the height adjustable suspension of vehicle 100 to raise the chassis of vehicle 100.

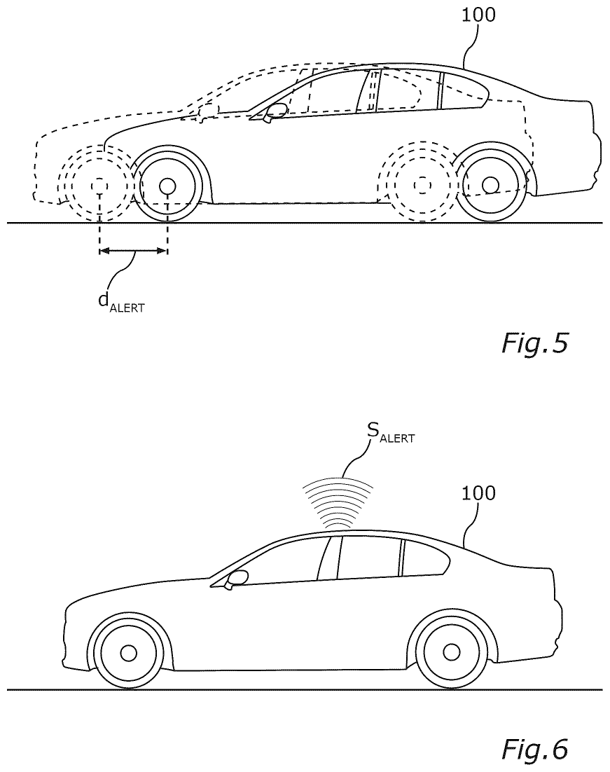

In a further example, the first pre-departure movement may be a longitudinal back and forth movement. The longitudinal back and forth movement may be configured to cause vehicle 100 to move forward by an alert distance d_{ALERT} and to reverse by alert distance d_{ALERT}, as e.g. illustrated in FIG. 5, or to reverse by alert distance d_{ALERT} and to move forward by alert distance d_{ALERT}. Alert distance d_{ALERT} is configured to alert VRUs 302 in the vicinity of vehicle 100 of an impending autonomous departure of vehicle 100 from the parking position without endangering VRUs 302 in the vicinity of the vehicle. Method 100 may cause vehicle 100 to move back and forth by alert distance d_{ALERT} by instructing an engine of vehicle 100 to advance by alert distance d_{ALERT} and to reverse by alert distance d_{ALERT}. Alert distance d_{ALERT} may be any kind of distance alerting VRUs 302 enabling alerting VRUs 302 of the impending departure of unoccupied vehicle 100 without endangering VRUs 302. To this end, alert distance d_{ALERT} may e.g. be less than 10 cm. For example, alert distance d_{ALERT} may be chosen so that vehicle 100 is perceived by VRUs 302 to be shaking. Such a value of alert distance d_{ALERT} may for example prevent endangering hands of children playing in the vicinity of the tires of vehicle 100.

In yet a further example, the first pre-departure movement may be a steering motion, i.e. a turning motion of the front wheels of vehicle 100. The steering motion may alert VRUs 302 in the vicinity of vehicle 100 to the impending autonomous departure of vehicle 100 from the parking position and thereby prevent endangering VRUs 302 who may not expect a departure of vehicle 100 given the absence of any passengers in vehicle 100.

It will be understood that the downward movement, the longitudinal back and forth movement and the steering motion are merely provided as examples of the first pre-departure movement. Accordingly, the first pre-departure movement may be any kind of movement of vehicle 100 prior to the departure of vehicle 100 from the parking position, which alerts VRUs 302 of the impending departure of vehicle 100 without endangering VRUs 302 and in particular children playing under or near the underside of vehicle 100.

In addition to the first pre-departure movement, method 400 may further cause vehicle 100 to perform a second pre-departure movement prior to causing vehicle 100 to autonomously depart the parking position without supervision. Like the first pre-departure movement, the second pre-departure movement may be configured to prevent endangering VRUs 302 in the vicinity of vehicle 100. For example, method 400 may cause vehicle 100 to perform the downward movement as the first pre-departure movement and may cause vehicle 100 to perform the longitudinal back and forth movement or the steering motion as the second pre-departure movement or more generally any kind of movement alerting VRUs 302 of the impending departure of vehicle 100 without endangering VRUs 302.

It will be understood that method 400 may perform further pre-departure movements or repeat pre-departure movements in order to enhance the warning of the impending departure without supervision provided to VRUs 302

Method 400 may further perform a step 404, in which method 400 causes vehicle 100 to emit an alert sound S_{ALERT}, as for example illustrated in FIG. 6, prior to causing vehicle 100 to autonomously depart a parking position without supervision. Alert sound S_{ALERT} may be configured to alert VRUs 302 in the vicinity of vehicle 100 of the impending autonomous departure of vehicle 100 from the parking position. Alert sound may for example be at least one of a car horn sound, a car unlock sound and an acoustic vehicle alerting system (AVAS) sound, as e.g. defined by the National Highway Traffic Society Administration (NHTSA) in final rule 87 FR 41618 or any superseding rule or as defined by the European Union (EU) in Commission Delegated Regulation (EU) 2019/839 or any superseding regulation or any similar rule by a governmental or supra-governmental agency. In other words, alert sound S_{ALERT} may correspond to at least one sound which vehicle 100 may also emit for another purpose. Alert sound S_{ALERT} may correspond to a single one of the sounds which vehicle 100 emits also for another purpose or may be a combination of these sounds. Alert sound S_{ALERT} may also be a voice message announcing the impending autonomous departure of the vehicle, which may be emitted alone or in combination with any of the other sounds discussed above. Emitting alert sound S_{ALERT} in addition to the first and in some examples of the present disclosure second and further pre-departure movements further enhances the warning provided to VRUs 302 of the impending departure of vehicle 100 without supervision.

To avoid unnecessarily emitting alert sound S_{ALERT}, e.g. to reduce noise pollution, method 400 may further include steps 405 and/or 406. In step 405, method 400 may suppress the alert sound S_{ALERT} depending on the time of day. In other words, method 400 may suppress alert sound S_{ALERT} in timeframes in which people in the vicinity of vehicle 100 may be more susceptible to noise and less likely to be so close to vehicle 100 as to warrant emitting alert sound S_{ALERT}, such as during the night. In step 406, method 400 may suppress alert sound S_{ALERT} in response to not detecting VRUs 302 in the vicinity of vehicle 100 using one or more sensors, such as sensors 110 shown in FIG. 3. Sensors 110 may include any types of sensors providing data indicative of the environment of vehicle 100, such as radar sensors, light detection and ranging (LIDAR) sensors, cameras or infrared cameras.

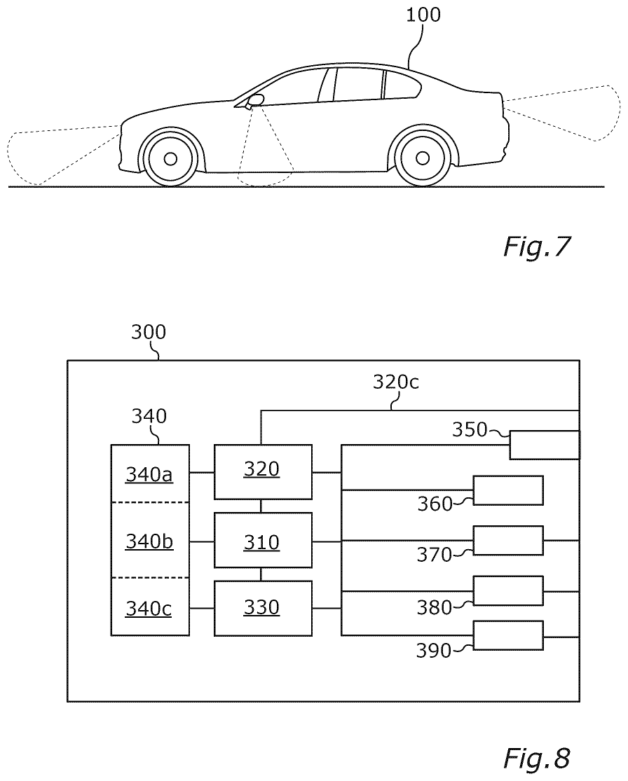

To further enhance the warning provided to VRUs 302 of the impending departure of vehicle 100 without supervision, method 400 may further include step 407, in which method 400 causes at least one light, such as at least one of lights 120 of vehicle 100 shown in FIG. 3, to flash for an alert time interval, as e.g. illustrated by the dashed light cones emitted by lights 120 of vehicle 100 in FIG. 7. Flashing for the alert time interval may alert VRUs 302 in the vicinity of vehicle 100 of the impending autonomous departure of vehicle 100 from the parking position. The duration of the alert time interval may be determined based on timeframes required to draw the attention of VRUs 302 to vehicle 100. To avoid unnecessarily flashing one or more of lights 120, method 400 may further include step 408, in which method 400 suppresses flashing of one or more lights 120 for the alert time interval in response to not detecting VRUs 302 in the vicinity of vehicle 100 using one or more sensors 110.

To further enhance the warning provided to VRUs 302 of the impending departure of vehicle 100 without supervision, method 400 may further include a step, in which method 400 may cause vehicle 100 to project at least one alert ground projection on a ground surface in the vicinity of vehicle 100. The alert ground projection may include imagery configured to alert VRUs 302 in the vicinity of vehicle 100 to an impending autonomous departure of vehicle 100 from the parking position. The imagery may be helpful to alert VRUs 302 of the impending departure of vehicle 100 who may not be able to perceive sound. The alert ground projection may be generated by a ground projection device integrated with one or more doors of vehicle 100, e.g. with the door handles, which may also be used to generate ground projections welcoming user 301 of vehicle 100.

In step 409, method 400 causes vehicle 100 to autonomously drive to the vehicle retrieval location in response to receiving a command from user 301 instructing the vehicle to autonomously drive to the vehicle retrieval location. For example, user 301 may summon vehicle 100 to the vehicle retrieval location using a device with cellular connection capability, such as a cell phone or a smart watch. Accordingly, vehicle 100 may receive the summoning command via a cellular network. Depending on the distance between vehicle 100 and user 301 and the communication capabilities of the device of user 301 and vehicle 100, the summoning command may also be provided to vehicle 100 via a Bluetooth connection, a Wi-Fi connection or any other wireless data connection capable of providing the summoning command and the location of user 301 to vehicle 100. The summoning command may also be provided automatically, i.e. without intervention from user 301, e.g. by the device with cellular and/or further communication capabilities of user 301 or a car key in possession of user 301, once user 301 enters or approaches the parking facility itself or a designated vehicle retrieval area of the parking facility. As stated above, the vehicle retrieval location may be the location of user 301 or a designated vehicle retrieval area of the parking facility. If the vehicle retrieval location is the location of user 301, the location of user 301 may be provided to vehicle 301 alongside the summoning command and may be updated if user 301 continues to move after the summoning command has been sent by user 301. If the vehicle retrieval location is a designated vehicle retrieval area of the parking facility, the designated vehicle retrieval area may be communicated to vehicle 301 alongside the summoning command, may be provided to vehicle 100 by the parking facility, e.g. by a signal broadcast by the parking facility to all vehicles at the parking facility, or may be known to vehicle 100 from map data or other navigational data provided to vehicle 100, e.g. for implementing advanced driver-assistance systems (ADASs) as well as autonomous driving capabilities.

To cause vehicle 100 to drive autonomously and without supervision to the vehicle retrieval location in step 409, method 100 may instruct an autonomous driving function of vehicle 100 to drive to the vehicle retrieval location as received from the device of user 301 or the parking facility or as known to vehicle 100.

As shown in FIG. 3, vehicle 100 may include an automotive control unit 300, which may be configured to perform method 400. Automotive control unit 300 may be discussed in detail in the following with regard to FIG. 8.

FIG. 8 shows automotive control unit 300 configured to perform method 400. automotive control unit 300 may include a processor 310, a graphics processing unit (GPU) 320, automotive processing system 330, a memory 340, a removable storage 350, a storage 360, a cellular interface 370, a global navigation satellite system (GNSS) interface 380 and a communication interface 390.

Processor 310 may be any kind of single-core or multi-core processing unit employing a reduced instruction set (RISC) or a complex instruction set (CISC). Exemplary RISC processing units include ARM based cores or RISC V based cores. Exemplary CISC processing units include x86 based cores or x86-64 based cores. Processor 310 may perform instructions causing automotive control unit 300 to perform method 400. Processor 310 may be directly coupled to any of the components of computing device 300 or may be directly coupled to memory 330, GPU 320 and a device bus.

GPU 320 may be any kind of processing unit optimized for processing graphics related instructions or more generally for parallel processing of instructions. As such, GPU 320 may be configured to generate a display of information, such as ADAS information or telemetry data, to a driver of the vehicle, e.g. via a head-up display (HUD) or a display arranged within the view of the driver. GPU 320 may be coupled to the HUD and/or the display via connection 320C. GPU 320 may further perform at least a part of method 400 to enable fast parallel processing of instructions relating to method 400. It should be noted that in some embodiments, processor 310 may determine that GPU 320 need not perform instructions relating to method 100. GPU 320 may be directly coupled to any of the components of computing device 300 or may be directly coupled to processor 310 and memory 330. In some embodiments, GPU 320 may also be coupled to the device bus

Automotive processing system 330 may be any kind of system-on chip configured to provide trillions of operations per second (TOPS) in order to enable automotive control unit 300 to implement one or more ADAS while driving. Automotive processing system 330 may interface only with processor 310 or may interface with other devices via the system bus.

Memory 340 may be any kind of fast storage enabling processor 310, GPU 320 and automotive processing system 330 to store instructions for fast retrieval during processing of instructions as well as to cache and buffer data. Memory 340 may be a unified memory coupled to processor 310 and GPU 320 and automotive processing system 330 in order to enable allocation of memory 340 to processor 310, GPU 320 and automotive processing system 330 as needed. Alternatively, processor 310, GPU 320 and automotive processing system 330 may be coupled to separate processor memory 340a, GPU memory 340b and automotive processing system memory 340c.

Removable storage 350 may be a storage device which can be removably coupled with automotive control unit 300. Examples include a digital versatile disc (DVD), a compact disc (CD), a Universal Serial Bus (USB) storage device, such as an external SSD, or a magnetic tape. It should be noted that removable storage 350 may store data, such as instructions of method 400, or may be omitted.

Storage 360 may be a storage device enabling storage of program instructions and other data. For example, storage 360 may be a hard disk drive (HDD), a solid state disk (SSD) or some other type of non-volatile memory. Storage 360 may for example store the instructions of method 400.

Removable Storage 350 and storage 360 may be coupled to processor 310 via the system bus. The system bus may be any kind of bus system enabling processor 310 and optionally GPU 320 as well as automotive processing system 330 to communicate with the other devices of automotive control unit 300. Bus 340 may for example be a Peripheral Component Interconnect express (PCIe) bus or a Serial AT Attachment (SATA) bus.

Cellular interface 370 may be any kind of interface enabling automotive control unit 300 to communicate via a cellular network, such as a 4G network or a 5G network.

GNSS interface 380 may be any kind of interface enabling automotive control unit 300 to receive position data provided by a satellite network, such as the Global Positioning System (GPS), the Global Navigation Satellite System (GLONASS) or Galileo.

Communications interface 390 may enable computing device 300 to interface with external devices, either directly or via network, via connection 380C. Communications interface 380 may for example enable computing device 300 to couple to a wired or wireless network, such as Ethernet, Wifi, a Controller Area Network (CAN) bus or any bus system appropriate in vehicles. For example, automotive control unit 300 may be coupled to any of the components of vehicle 100 necessary to perform the first pre-departure movement or to alert any VRUs in the vicinity of vehicle 100 of the impending departure of vehicle 100 as defined above with regard to method 400. Communications interface 390 may also include a USB port or a serial port to enable direct communication with an external device.

Automotive control unit 300 may be integrated with the vehicle, e.g. beneath the cabin, under the dashboard or in the trunk of vehicle 100.

The invention may further be illustrated by the following examples.

In an example, an exemplary method for unsupervised maneuvering of a vehicle comprises, prior to causing the vehicle to autonomously depart a parking position without supervision, causing the vehicle to perform a first pre-departure movement configured to prevent VRUs in a vicinity of the vehicle and, in response to receiving a command from a user of the vehicle instructing the vehicle to autonomously drive to a vehicle retrieval location, causing the vehicle to autonomously drive to the vehicle retrieval location, wherein the parking position is located outside a field of view of the user.

In the exemplary method, the first pre-departure movement may be a downward movement configured to reduce a ground clearance of the vehicle, causing the vehicle to perform the first pre-departure movement may be performed upon the vehicle arriving at the parking position, and the exemplary method may further comprise causing the vehicle to reverse the first pre-departure movement before causing the vehicle to drive to the vehicle retrieval location.

The exemplary method may further comprise, prior to causing the vehicle to autonomously depart a parking position without supervision, causing the vehicle to perform a second pre-departure movement configured to prevent endangering the VRUs in the vicinity of the vehicle, wherein the second pre-departure movement may be one of a longitudinal back and forth movement and a steering motion, wherein the longitudinal back and forth movement may be configured to cause the vehicle to move forward by an alert distance and to reverse by the alert distance, the alert distance being configured to alert the VRUs in the vicinity of the vehicle of an impending autonomous departure of the vehicle from the parking position without endangering the VRUs in the vicinity of the vehicle, and wherein the steering motion may be a turning motion of front wheels of the vehicle.

In the exemplary method, the first pre-departure movement may be one of a longitudinal back and forth movement and a steering motion, the longitudinal back and forth movement may be configured to cause the vehicle to move forward by an alert distance and to reverse by the alert distance, the alert distance being configured to alert the VRUs in the vicinity of the vehicle of an impending autonomous departure of the vehicle from the parking position without endangering the VRUs in the vicinity of the vehicle, and the steering motion may be a turning motion of front wheels of the vehicle.

The exemplary method may further comprise, prior to causing the vehicle to autonomously depart a parking position without supervision, causing the vehicle to emit an alert sound, the alert sound being configured to alert the VRUs in the vicinity of the vehicle of an impending autonomous departure of the vehicle from the parking position.

In the exemplary method, the alert sound may be at least one of a car horn sound, a car unlock sound and an acoustic vehicle alerting system (AVAS) sound.

In the exemplary method, the alert sound is a voice message announcing the impending autonomous departure of the vehicle.

The exemplary method may further comprise at least one of suppressing the alert sound depending on the time of day, or suppressing the alert sound in response to not detecting the VRUs in the vicinity of the vehicle using one or more sensors of the vehicle.

The exemplary method may further comprise causing at least one light of the vehicle to flash for an alert time interval, the flashing for the alert time interval being configured to alert the VRUs in the vicinity of the vehicle of an impending autonomous departure of the vehicle from the parking position.

The exemplary method may further comprise, suppressing the flashing of the at least one light for the alert time interval in response to not detecting the VRUs in the vicinity of the vehicle using one or more sensors of the vehicle.

The exemplary method may further comprise causing the vehicle to project at least one alert ground projection on a ground surface in the vicinity of the vehicle, the alert ground projection including imagery configured to alert VRUs in the vicinity of the vehicle to an impending autonomous departure of the vehicle from the parking position.

In an example, an exemplary automotive control unit comprises at least one processing unit and a memory coupled to the at least one processing unit and configured to store machine-readable instructions, wherein the machine-readable instructions cause the at least one processing unit to, prior to causing a vehicle to autonomously depart a parking position without supervision, cause the vehicle to perform a first pre-departure movement configured to prevent endangering VRUs in a vicinity of the vehicle; and in response to receiving a command from a user of the vehicle instructing the vehicle to autonomously drive to the vehicle retrieval location, cause the vehicle to autonomously drive to the vehicle retrieval location, wherein the parking position is located outside a field of view of the user.

In the exemplary automotive control unit, the machine-readable instructions further cause the at least one processing unit to perform the exemplary method discussed above.

In an example, an exemplary vehicle may comprise the exemplary automotive control unit discussed above.

The preceding description has been provided to illustrate unsupervised maneuvering of a vehicle in a parking facility. It should be understood that the description is in no way meant to limit the scope of the present disclosure to the precise embodiments discussed throughout the description. Rather, the person skilled in the art will be aware that the examples of the present disclosure may be combined, modified or condensed without departing from the scope of the present disclosure as defined by the following claims. The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 Vehicle
301 User
302 VRUs
110 sensor
120 light
300 automotive control unit
310 CPU
320 GPU
320c connection
330 automotive processing system
340 memory
350 removable storage
360 storage
370 cellular interface
380 GNSS interface
390 communications interface
400 method
410-409 method steps
d₁ first distance
d₂ second distance
d_{ALERT} alert distance
S_{ALERT} alert sound

What is claimed is:

1. A method for unsupervised maneuvering of a vehicle, comprising:
prior to causing the vehicle to autonomously depart a parking position without supervision, causing the vehicle to perform a first pre-departure movement configured to prevent endangering vulnerable road users (VRUs) in a vicinity of the vehicle; and
in response to receiving a command from a user of the vehicle instructing the vehicle to autonomously drive to a vehicle retrieval location, causing the vehicle to autonomously drive to the vehicle retrieval location,
wherein the parking position is located outside a field of view of the user.

2. The method of claim 1, wherein:
the first pre-departure movement is a downward movement configured to reduce a ground clearance of the vehicle,
causing the vehicle to perform the first pre-departure movement is performed upon the vehicle arriving at the parking position, and
the method further comprises causing the vehicle to reverse the first pre-departure movement before causing the vehicle to drive to the vehicle retrieval location.

3. The method of claim 2, further comprising:
prior to causing the vehicle to autonomously depart a parking position without supervision, causing the vehicle to perform a second pre-departure movement configured to prevent endangering the VRUs in the vicinity of the vehicle,
wherein the second pre-departure movement is one of a longitudinal back and forth movement and a steering motion,
wherein the longitudinal back and forth movement is configured to cause the vehicle to move forward by an alert distance and to reverse by the alert distance, the alert distance being configured to alert the VRUs in the vicinity of the vehicle of an impending autonomous departure of the vehicle from the parking position without endangering the VRUs in the vicinity of the vehicle, and
wherein the steering motion is a turning motion of front wheels of the vehicle.

4. The method of claim 1, wherein:
the first pre-departure movement is one of a longitudinal back and forth movement and a steering motion,
the longitudinal back and forth movement is configured to cause the vehicle to move forward by an alert distance and to reverse by the alert distance, the alert distance being configured to alert the VRUs in the vicinity of the vehicle of an impending autonomous departure of the vehicle from the parking position without endangering the VRUs in the vicinity of the vehicle, and
the steering motion is a turning motion of front wheels of the vehicle.

5. The method of claim 1, further comprising:
prior to causing the vehicle to autonomously depart a parking position without supervision, causing the vehicle to emit an alert sound,
wherein the alert sound is configured to alert the VRUs in the vicinity of the vehicle of an impending autonomous departure of the vehicle from the parking position.

6. The method of claim 5, wherein
the alert sound is at least one of a car horn sound, a car unlock sound and an acoustic vehicle alerting system (AVAS) sound.

7. The method of claim 5, wherein the alert sound is a voice message announcing the impending autonomous departure of the vehicle.

8. The method of claim 5, further comprising at least one of:
suppressing the alert sound depending on a time of day, or
suppressing the alert sound in response to not detecting the VRUs in the vicinity of the vehicle using one or more sensors of the vehicle.

9. The method of claim 1, further comprising:
causing at least one light of the vehicle to flash for an alert time interval,
wherein the flashing for the alert time interval is configured to alert the VRUs in the vicinity of the vehicle of an impending autonomous departure of the vehicle from the parking position.

10. The method of claim 9, further comprising:
suppressing the flashing of the at least one light for the alert time interval in response to not detecting the VRUs in the vicinity of the vehicle using one or more sensors of the vehicle.

11. The method of claim 1, further comprising:
causing the vehicle to project at least one alert ground projection on a ground surface in the vicinity of the vehicle, the alert ground projection including imagery configured to alert VRUs in the vicinity of the vehicle to an impending autonomous departure of the vehicle from the parking position.

12. An automotive control unit, comprising:
at least one processing unit; and
a memory coupled to the at least one processing unit and configured to store machine-readable instructions,
wherein the machine-readable instructions cause the at least one processing unit to:
prior to causing a vehicle to autonomously depart a parking position without supervision, cause the vehicle to perform a first pre-departure movement configured to prevent endangering vulnerable road users (VRUs) in a vicinity of the vehicle; and
in response to receiving a command from a user of the vehicle instructing the vehicle to autonomously drive to the vehicle retrieval location, cause the vehicle to autonomously drive to the vehicle retrieval location,
wherein the parking position is located outside a field of view of the user.

13. The automotive control unit of claim 12, wherein
the first pre-departure movement is a downward movement configured to reduce a ground clearance of the vehicle,
the causing of the vehicle to perform the first pre-departure movement is performed upon the vehicle arriving at the parking position, and
wherein the machine-readable instructions further cause the at least one processing unit to:
cause the vehicle to reverse the first pre-departure movement before causing the vehicle to drive to the vehicle retrieval location.

14. The automotive control unit of claim 13, wherein the machine-readable instructions further cause the at least one processing unit to:
prior to causing the vehicle to autonomously depart a parking position without supervision, cause the vehicle to perform a second pre-departure movement configured to prevent endangering the VRUs in the vicinity of the vehicle,
wherein the second pre-departure movement is one of a longitudinal back and forth movement and a steering motion,
wherein the longitudinal back and forth movement is configured to cause the vehicle to move forward by an alert distance and to reverse by the alert distance, the alert distance being configured to alert the VRUs in the vicinity of the vehicle of an impending autonomous departure of the vehicle from the parking position without endangering the VRUs in the vicinity of the vehicle, and
wherein the steering motion is a turning motion of front wheels of the vehicle.

15. The automotive control unit of claim 13, wherein
the first pre-departure movement is one of a longitudinal back and forth movement and a steering motion,
the longitudinal back and forth movement is configured to cause the vehicle to move forward by an alert distance and to reverse by the alert distance, the alert distance being configured to alert the VRUs in the vicinity of the vehicle of an impending autonomous departure of the vehicle from the parking position without endangering the VRUs in the vicinity of the vehicle, and
the steering motion is a turning motion of front wheels of the vehicle.

16. The automotive control unit of claim 13, wherein the machine-readable instructions further cause the at least one processing unit to:
prior to causing the vehicle to autonomously depart a parking position without supervision, cause the vehicle to emit an alert sound,
wherein the alert sound is configured to alert the VRUs in the vicinity of the vehicle of an impending autonomous departure of the vehicle from the parking position.

17. The automotive control unit of claim 13, wherein the machine-readable instructions further cause the at least one processing unit to:
suppress the alert sound depending on a time of day, or
suppress the alert sound in response to not detecting the VRUs in the vicinity of the vehicle using one or more sensors of the vehicle.

18. The automotive control unit of claim 13, wherein the machine-readable instructions further cause the at least one processing unit to:
cause at least one light of the vehicle to flash for an alert time interval,
wherein the flashing for the alert time interval is configured to alert the VRUs in the vicinity of the vehicle of an impending autonomous departure of the vehicle from the parking position.

19. The automotive control unit of claim 13, wherein the machine-readable instructions further cause the at least one processing unit to:
cause the vehicle to project at least one alert ground projection on a ground surface in the vicinity of the vehicle, the alert ground projection including imagery configured to alert VRUs in the vicinity of the vehicle to an impending autonomous departure of the vehicle from the parking position.

20. A vehicle comprising the automotive control unit of claim 12.
